(19) United States
(12) Patent Application Publication
(10) Pub. No.: US 2023/0237214 A1
(43) Pub. Date: Jul. 27, 2023

(54) Positioning Correction Method of Near Seabed Video Data Based on Ultra-short Baseline

(71) Applicants: The First Institute of Oceanography, MNR, Qingdao (CN); Pilot National Laboratory for Marine Science and Technology (Qingdao), Qingdao (CN); National Marine Data Information Center, Tianjin (CN)

(72) Inventors: Shijuan YAN, Qingdao (CN); Yue ZHAO, Qingdao (CN); Chuanshun LI, Qingdao (CN); Gang YANG, Qingdao (CN); Dewen DU, Qingdao (CN); Jun YE, Qingdao (CN); Zhiwei ZHU, Qingdao (CN); Xiangwen REN, Qingdao (CN); Chunhua HAN, Qingdao (CN); Fengdeng SHI, Qingdao (CN); Qiukui ZHAO, Qingdao (CN); Xinyu SHI, Qingdao (CN)

(73) Assignees: The First Institute of Oceanography, MNR, Qingdao (CN); Pilot National Laboratory for Marine Science and Technology (Qingdao), Qingdao (CN); National Marine Data Information Center, Tianjin (CN)

(21) Appl. No.: 17/699,134

(22) Filed: Mar. 20, 2022

(30) Foreign Application Priority Data
Jan. 26, 2022 (CN) 202210093798.3

(51) Int. Cl. G06F 30/20; G06T 17/05; G06T 19/20; G01S 19/45

(52) U.S. Cl. CPC G06F 30/20; G06T 17/05; G06T 19/20; G01S 19/45; G06T 2219/2004; G06F 2111/10

(57) ABSTRACT

Disclosed is a near-seabed video data positioning correction method based on an ultra-short baseline, comprising the following steps: acquiring ultra-short baseline positioning data; eliminating abnormal data in the ultra-short baseline positioning data, establishing a four-dimensional elimination model, and eliminating the abnormal data in X, Y and Z directions; modeling the correction method of the recombined ultra-short baseline positioning data after removing abnormal data; obtaining the positioning data of the camera drag with specified precision by simulation. The application realizes the positioning correction of video data under the existing conditions and established operation modes, and eliminates, simulates and corrects the error data generated by the time change of ultra-short baseline data used for video positioning in the heading and other directions by integrating and using various survey data, so as to position the near-bottom video data.

### CROSS-REFERENCE TO RELATED APPLICATIONS

This application claims priority to Chinese Patent Application No. 202210093798.3, filed on Jan. 26, 2022, the contents of which are hereby incorporated by reference.

### TECHNICAL FIELD

The application relates to the technical field of seabed mineral resources exploration, and in particular to a positioning correction method of near seabed video data based on an ultra-short baseline.

### BACKGROUND

With the mature application of the deep-sea high-definition camera and the photographic technology, a near-seabed camera survey has become an intuitive detection means of a deep-sea mineral resources survey. At present, the most typical deep-sea exploration platform equipped with a deep-sea camera and photographic equipment is the towed exploration platform. In addition, it is necessary to locate the underwater camera equipment mounted on the towed exploration platform, and the accurate positioning is the basis for further in-depth resource investigation and scientific research.

At present, underwater positioning of towed exploration platform is generally realized by means of an ultra-short baseline fixed on the platform, which has become a routine means of deep-sea scientific research in recent years with a fast positioning speed and a high accuracy. However, due to the measurement environment and other factors, wrong data or even missing data will be caused to various degrees, which will bring troubles to the underwater positioning of deep-sea camera equipment. Therefore, effective processing and correction of ultra-short baseline positioning data is the premise to ensure that the near-bottom video data can be further excavated and utilized. It is necessary to effectively process and correct the ultra-short baseline positioning data, so that the camera data could obtain more accurate positioning and be better used for deep-sea prospecting.

According to the existing technology, most of the processing of ultra-short baseline is to eliminate the abnormal values in space, rather than eliminating the error data generated by the change of time along the heading, thus failing to achieve a good correction effect. Moreover, most of the existing technologies only analyze and process the ultra-short baseline positioning data itself; if there are many delays in the ultra-short baseline data, there are limitations which affect the accuracy of the correction results. With the improvement of detection technology, it is generally possible to use multiple detection methods to investigate the same target at the same time, and obtain various related data. However, there is no specific correction method for comprehensive analysis by combining various data at present. Therefore, the present application proposes a positioning correction method of near-seabed video data based on ultra-short baseline to solve the problems existing in the prior art.

### SUMMARY

In view of the above problems, the objective of the present application is to propose a positioning correction method of near-seabed video data based on ultra-short baseline, which solves the problems of unsatisfactory and inaccurate correction effect of the correction method for ultra-short baseline positioning data in the prior art.

In order to achieve the above objectives, this application is realized by the following technical scheme: a positioning correction method of near-seabed video data based on ultra-short baseline including the following steps:

S1: acquiring ultra-short baseline positioning data, and acquiring ultra-short baseline positioning data including longitude information, latitude information and a first water depth value by using an ultra-short baseline positioning system;

S2: establishing a four-dimensional elimination model, eliminating abnormal data in ultra-short baseline positioning data, and obtaining processed recombined ultra-short baseline positioning data;

S3: simulating, correcting and modelling the processed recombined ultra-short baseline positioning data from the perspective of time series; and

S4: using the model established in S3 to simulate and interpolate the corrected recombined ultra-short baseline positioning data, so as to obtain near-seabed video positioning.

The further improvement is that eliminating abnormal data in ultra-short baseline positioning data in S2 specifically includes the following steps:

A1: establishing a four-dimensional elimination model by using time, longitude, latitude and water depth information in ultra-short baseline positioning data from the perspective of time and space sequence;

A2: judging whether the first water depth value is abnormal according to the four-dimensional elimination model, eliminating the ultra-short baseline positioning data with abnormal first water depth value if abnormal; and otherwise retaining the ultra-short baseline positioning data;

A3: establishing a buffer with a range of 0.3% of the average length of each measuring cable along the direction where the ultra-short baseline positioning data is aggregated;

A4: eliminating the ultra-short baseline positioning data outside the buffer to obtain the processed ultra-short baseline positioning data;

A5: the bathymetric data integrated with the processed ultra-short baseline positioning data is the second water depth value obtained by a conductivity-temperature-depth sensor, and the processed ultra-short baseline positioning data is one-to-one corresponding to the second water depth values according to time to obtain the recombined ultra-short baseline positioning data;

A6: using the function of extracting values to points in ArcToolbox of ArcGIS, and extracting water depth values from AUV sounding data according to the recombined ultra-short baseline positioning data; comparing the AUV water depth value with the water depth value formed by the recombined ultra-short baseline positioning data, and eliminating the points with obvious abnormal trend to keep the trend of the ultra-short baseline positioning data relatively consistent with the topography of AUV sounding data in the same area; and

A7: in terms of heading, with the assistance of ship-borne GPS positioning data, monitoring the change frequency of two sets of positioning data based on the change position of time and ultra-short baseline positioning data in heading as well as the navigation direction and speed data, and eliminating the abnormal data of ultra-short baseline in X direction.

The further improvement is that the way to judge the abnormality of the first water depth value in A2 is to arrange the ultra-short baseline positioning data of a survey line in time sequence in the direction of the first water depth value of the four-dimensional elimination model to obtain the abnormal water depth point, and to eliminate the ultra-short baseline positioning data of the abnormal point.

The further improvement is that the sounding data integrated with the processed ultra-short baseline positioning data in the S 2 is the second water depth value obtained by the conductivity-temperature-depth sensor, and the processed ultra-short baseline positioning data are in one-to-one correspondence with the second water depth values to obtain recombined ultra-short baseline positioning data according to the time.

The further improvement is that the culling operation in the S 2 specifically utilizes the function of extracting values to points in ArcToolbox of ArcGIS, extracts the water depth values in AUV sounding data by using the recombined ultra-short baseline positioning data, and carries out cross-section comparative analysis on the water depth values of AUV and those formed by the recombined ultra-short baseline positioning data to cull points with obvious abnormal trends; and thus make the ultra-short baseline positioning data and the terrain of AUV sounding data in the same area keep relatively consistent fluctuation.

The further improvement lies in that the culling operation in S2 specifically monitors the changing frequency of two sets of positioning data by means of ship-borne GPS positioning data, through the changing position of time and ultra-short baseline positioning data on the heading, supplemented by navigation direction and speed data, and culls the abnormal data of ultra-short baseline in the X direction.

The further improvement is that the correction method in S3 specifically comprise the following steps:

B1: respectively calculating the correction coefficients of longitude and latitude after removing abnormal points by the cubic polynomial least square fitting method, and determining a fitting formula according to the correction coefficients;

B2: fitting the processed recombined ultra-short baseline positioning data by using fitting formula, and further determining the correction model by testing the fitting effect of the recombined ultra-short baseline positioning data after removing anomalies.

The further improvement is that before the fitting formula in step B1 is determined, the data is centralized and standardized, and the determined fitting formula is expressed as follows:

f(x)=p₁x³+p₂x²+p₃x+p₄

where p₁, p₂, p₃ are the correction coefficients, and x is the number of all points.

The further improvement is that the error data, which is generated by the time change of the processed recombined ultra-short baseline positioning data on the ultra-short baseline heading, is corrected by the fitting formula in step B2, and the ultra-short baseline positioning data after spatial fitting is simulated with time as the constraint, which is video positioning data.

The further improvement is that in B2, the fitting formula is used to correct the error data generated by the change of the fitting recombined ultra-short baseline positioning data along the ultra-short baseline heading with the time; and simulating the ultra-short baseline positioning data, video positioning data, which is constrained by time and has undergone spatial fitting.

The method has the beneficial effects that: comprehensive analysis is carried out based on ultra-short baseline positioning data, combined with AUV high-resolution sounding data, pressure sensor sounding data, ship-borne GPS positioning data, wherein various data are fused, and a four-dimensional elimination model of abnormal data is established; the error data generated by ultra-short baseline positioning data in time series, heading, vertical heading and vertical direction are eliminated, and the cubic polynomial least square correction model is established to carry out simulation correction to realize the positioning correction of video data under the existing conditions and the established operation mode.

### BRIEF DESCRIPTION OF THE DRAWINGS

FIG. 1 is a flow chart of the method of the present application.

FIG. 2 is a four-dimensional model diagram of the original ultra-short baseline positioning data in Example 2 of the present application.

FIG. 3 is a model diagram of buffer elimination in Example 2 of the present application.

FIG. 4 is a cross-sectional comparison diagram of Example 2 of the present application.

FIG. 5 is a comparison chart of water depth before and after correction in Example 2 of the present application.

FIG. 6 is a four-dimensional model diagram of the camera drag position after correction in Example 2 of the present application.

FIG. 7 is a detailed flow chart of S2 of Example 1 of the present application.

FIG. 8 is a detailed flow chart of S3 of the Example 1 of the present application.

### DETAILED DESCRIPTION OF THE EMBODIMENTS

In order to illustrate the present application, the present application will be described in further detail below with examples. The following examples are only used to explain the application, rather than limit the scope of protection of the application.

### Example 1

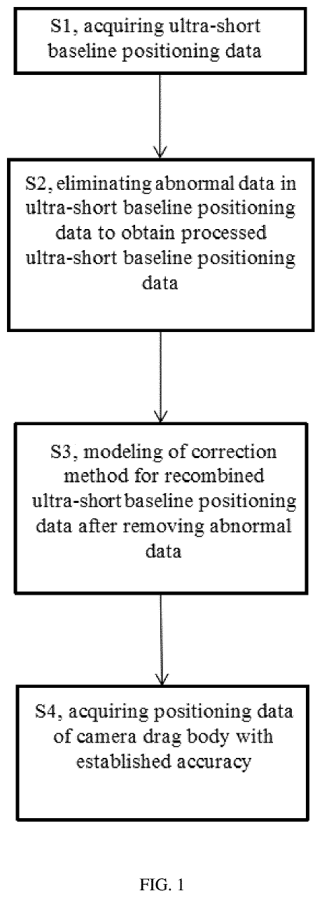

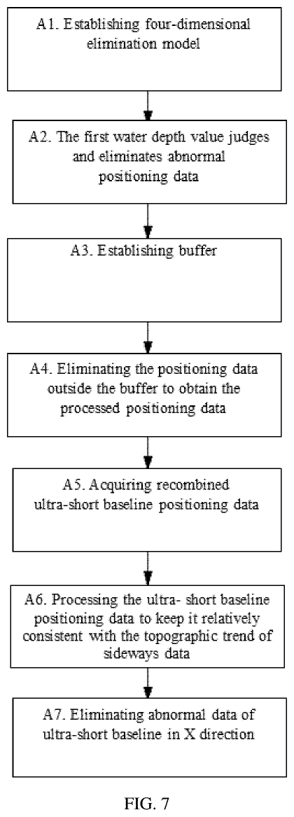

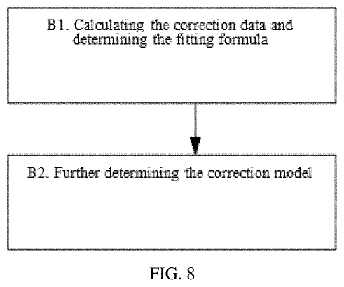

As shown in FIG. 1, FIG. 7 and FIG. 8, this example provides a positioning correction method of near-seabed video data based on an ultra-short baseline, including the following steps.

S1: acquiring ultra-short baseline positioning data, and acquiring ultra-short baseline positioning data including longitude information, latitude information and a first water depth value by using an ultra-short baseline positioning system.

S2: establishing a four-dimensional elimination model, eliminating abnormal data in ultra-short baseline positioning data, and obtaining processed recombined ultra-short baseline positioning data, which specifically includes the following steps as shown in FIG. 7, which is a detailed flow chart of S2 of Example 1 of the present application.

A1: from the perspective of time and space sequence, establishing a four-dimensional elimination model by using time, longitude, latitude and water depth information in ultra-short baseline positioning data.

A2: judging whether the first water depth value is abnormal according to the four-dimensional elimination model, eliminating the ultra-short baseline positioning data with abnormal first water depth value if abnormal, otherwise retaining the ultra-short baseline positioning data;

when performing judging, arranging the ultra-short baseline positioning data of a survey line in time sequence in the direction of the first water depth value of the four-dimensional elimination model, and obtaining the point of abnormal water depth; and eliminating the ultra-short baseline positioning data of abnormal points.

A3: establishing a buffer with a range of 0.3% of the average length of each measuring cable along the direction where the ultra-short baseline positioning data is aggregated.

A4: eliminating the ultra-short baseline positioning data outside the buffer to obtain the processed ultra-short baseline positioning data.

A5: the bathymetric data integrated with the processed ultra-short baseline positioning data is the second water depth value obtained by the conductivity-temperature-depth sensor, and the processed ultra-short baseline positioning data is one-to-one corresponding to the second water depth values according to time to obtain the recombined ultra-short baseline positioning data.

A6: according to the function of extracting values to points in ArcToolbox of ArcGIS, extracting the water depth values in Autonomous Underwater Vehicle (AUV) sounding data according to the recombined ultra-short baseline positioning data, and compare and analyzing the profiles of the AUV water depth values as well as the water depth values formed by the recombined ultra-short baseline positioning data, so as to eliminate the points with obvious abnormal trends; the trend of keeping the ultra-short baseline positioning data relatively consistent with the topography of AUV sounding data in the same area.

A7: on the heading, monitoring the change frequency of two sets of positioning data with the help of ship-borne GPS positioning data as well as the changing position of time and ultra-short baseline positioning data on the heading and supplemented by navigation direction and speed data; and thus to eliminate abnormal data of ultra-short baseline in X direction (heading).

S3: simulating, correcting and modelling the processed recombined ultra-short baseline positioning data from the perspective of time series, as shown in FIG. 8.

B1: first, use the cubic polynomial least square fitting method to calculate the correction coefficients of longitude and latitude after removing abnormal points respectively, and determine the fitting formula according to the correction coefficients, which is expressed as

f(x)=p₁x³+p₂x²+p₃x+p₄

wherein p₁, p₂, p₃ are the correction coefficients, and x is the number of all points.

B2: fitting the processed recombined ultra-short baseline positioning data by using a fitting formula, and further determining the correction model by testing the fitting effect of the recombined ultra-short baseline positioning data after removing anomalies.

S4: using a model established in S3 to simulate and interpolate the corrected recombined ultra-short baseline positioning data, so as to obtain near-seabed video positioning.

### Example 2

As shown in FIGS. 1-6, this example provides a positioning correction method of near-seabed video data based on an ultra-short baseline, including the following steps.

S1: acquiring ultra-short baseline positioning data in .txt format, and acquiring ultra-short baseline positioning data including longitude information, latitude information and a first water depth value by using an ultra-short baseline positioning system.

S2: removing abnormal data from ultra-short baseline positioning data to obtain processed ultra-short baseline positioning data, specifically including the following steps.

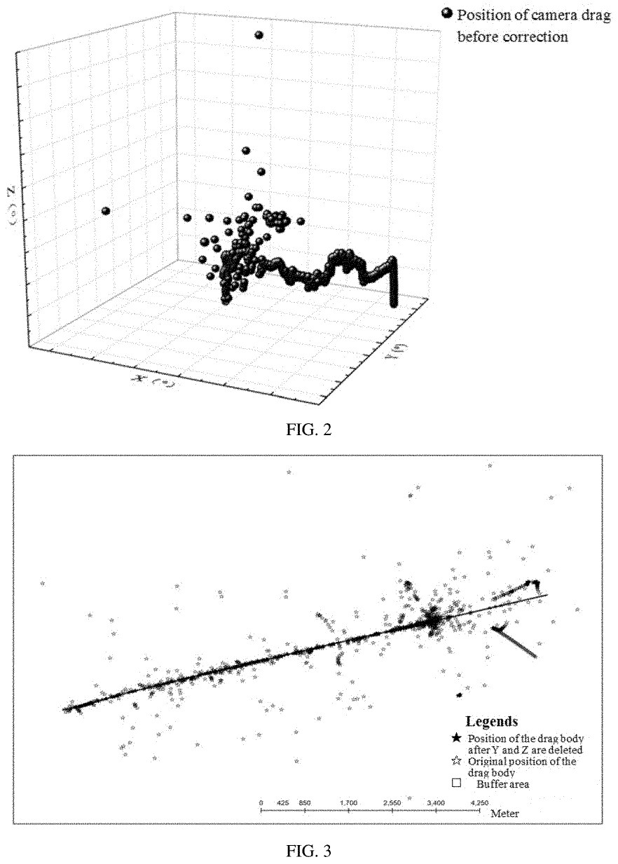

A1: according to the spatial sequence angle, establishing a four-dimensional elimination model by using longitude information, latitude information and a first water depth value in ultra-short baseline positioning data. As shown in FIG. 2, in the four-dimensional model, X represents the deviation distance of the target along the bow direction, that is longitude; Y represents the deviation distance of the target along the port and starboard directions of the mother ship, latitude; Z represents the deviation distance of the target along the vertical direction, the first water depth value; and T represents the time series.

A2: judging whether the first water depth value is abnormal according to the four-dimensional elimination model; if the value is abnormal, the ultra-short baseline positioning data with abnormal first water depth value is eliminated; otherwise, the ultra-short baseline positioning data is retained; and

when perform judging, arranging that ultra-short baseline position data of a survey line in time sequence in the direction of the first water depth value of the four-dimensional elimination model, and obtaining the point with abnormal water depth; and eliminating the ultra-short baseline positioning data of abnormal points.

A3: according to the buffer function of spatial analysis in ArcGIS, establishing a buffer with a range of 0.3% of the average length of each measuring cable along the direction of aggregated reliable drag position data.

A4: eliminating the ultra-short baseline positioning data outside the buffer and keep the data in the buffer, as shown in FIG. 3, to obtain the processed ultra-short baseline positioning data.

A5: integrating the processed ultra-short baseline positioning data with the second water depth value of the. txt format sounding data obtained by a conductivity-temperature-depth sensor; according to the time, the processed ultra-short baseline positioning data are in one-to-one correspondence with the second water depth values to obtain more reliable recombined ultra-short baseline positioning data, thus obtaining recombined ultra-short baseline positioning data.

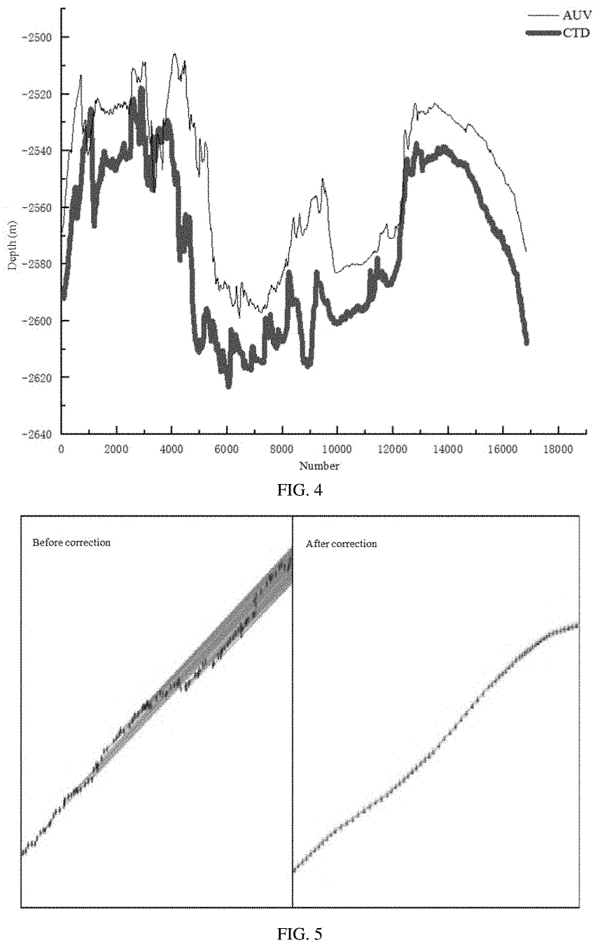

A6: eliminating the data of abnormal water depth in the recombined ultra-short baseline positioning data according to the AUV sounding data, specifically extracting the water depth value in the AUV sounding data by using the function of extracting values to points in ArcToolbox of ArcGIS, and then comparing and analyzing the profile between the AUV water depth value and the water depth value formed by the recombined ultra-short baseline positioning data, so as to eliminate the points with obvious abnormal trend; keeping the ultra-short baseline positioning data and the terrain of AUV sounding data in the same area relatively consistent ups and downs, and obtaining the processed recombined ultra-short baseline positioning data; as shown in FIG. 4, Conductivity Temperature Depth (CTD) in the figure represents the water depth value formed by recombinant ultra-short baseline positioning data.

A7: on the heading, monitoring the change frequency of two sets of positioning data with the help of ship-borne GPS positioning data as well as the changing position of time and ultra-short baseline positioning data on the heading and supplemented by navigation direction and speed data; and eliminating abnormal data of ultra-short baseline in X direction (heading).

After the operations in S1 and S2, the outliers that can be judged by human beings are eliminated. However, in the X direction, the points are disordered according to the time series, and the spatial position does not change with time. Therefore, only after the correction in S3, can the points be arranged in sequence, and the geographical position changes in the forward direction with the increase of time as shown in FIG. 6.

S3: simulating, correcting and modelling the processed recombined ultra-short baseline positioning data from the perspective of time series, specifically including the following steps.

B1: with the number (time sequence) as X, centralizing and standardizing the data, and then calculating the correction coefficients of longitude and latitude by cubic polynomial least square fitting method, and determining the fitting formula as follows according to the correction coefficients:

f(x)=p₁x³+p₂x²+p₃x+³₄

where p₁, p₂, p₃ are the correction coefficients, and x is the number of all points;

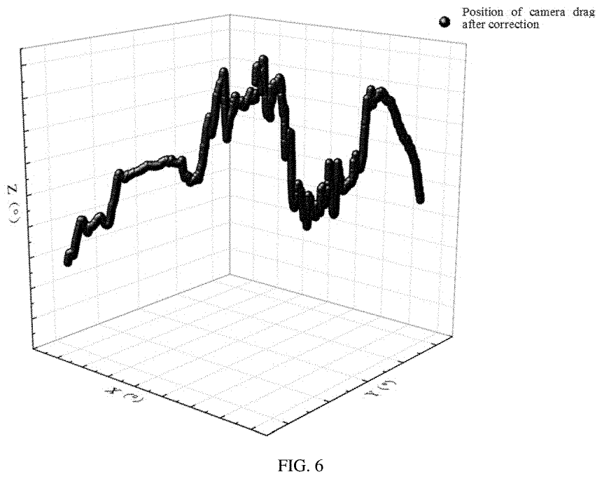

B2: fitting the processed recombined ultra-short baseline positioning data by using fitting formula, and further determining the correction model by checking the fitting effect of the recombined ultra-short baseline positioning data after removing anomalies to obtain the corrected recombined ultra-short baseline positioning data, as shown in FIG. 5 of the specification; and

S4: using the model established in S3 to simulate and interpolate the corrected recombined ultra-short baseline positioning data, so as to obtain near-seabed video positioning.

Short-term positioning failure will occur in the acquisition process of ultra-short baseline, and the positioning data is discontinuous and incomplete due to the elimination of some abnormal positioning data. Therefore, the positioning data of all time points are interpolated by using the correction model curve formed in S3, that is, the fitting formula, to obtain continuous positioning data of the camera drag. In order to further verify the method, a group of ultra-short baseline positioning data with good quality is selected to be compared with the corresponding positioning data simulated by quasi-merging interpolation. The verification results show that this method is effective.

The above descriptions show and illustrate the basic principle, main features and advantages of the present application. Those of ordinary skill in the industry should know that the present application is not limited by the above-mentioned embodiments. What is described in the above-mentioned embodiments and descriptions only illustrate the principles of the present application. Without departing from the spirit and scope of the present application, there will be various changes and improvements of the present application, which all fall within the scope of the claimed application. The scope of protection claimed by that present application is defined by the append claims and their equivalents.

What is claimed is:

1. A positioning correction method of near-seabed video data based on an ultra-short baseline, comprising the following steps:
S1: acquiring ultra-short baseline positioning data including longitude information, latitude information and a first water depth value by using an ultra-short baseline positioning system;
S2: establishing a four-dimensional elimination model, eliminating abnormal data in the ultra-short baseline positioning data, and obtaining processed recombined ultra-short baseline positioning data;
S3: simulating, correcting and modeling the processed recombined ultra-short baseline positioning data from the perspective of time series; and
S4: using a model established in S3 to simulate and interpolate corrected recombined ultra-short baseline positioning data, so as to obtain near-seabed video positioning.

2. The positioning correction method according to claim 1, wherein eliminating abnormal data in the ultra-short baseline positioning data in S2 specifically comprises the following steps:
A1: establishing a four-dimensional elimination model by using time, longitude, latitude and water depth information in the ultra-short baseline positioning data from the perspective of time and space sequence;
A2: judging whether the first water depth value is abnormal according to the four-dimensional elimination model, eliminating the ultra-short baseline positioning data with abnormal first water depth value if abnormal; and otherwise retaining the ultra-short baseline positioning data;
A3: establishing a buffer with a range of 0.3% of the average length of each measuring cable along the direction where the ultra-short baseline positioning data is aggregated;
A4: eliminating the ultra-short baseline positioning data outside the buffer to obtain the processed ultra-short baseline positioning data;
A5: taking bathymetric data integrated with the processed ultra-short baseline positioning data as second water depth values obtained by a conductivity-temperature-depth sensor, and corresponding the processed ultra-short baseline positioning data to the second water depth values according to time to obtain the recombined ultra-short baseline positioning data;
A6: using the function of extracting values to points in ArcToolbox of ArcGIS, and extracting water depth values from Autonomous Underwater Vehicle (AUV) sounding data according to the recombined ultra-short baseline positioning data, the AUV water depth value being compared with the water depth value formed by the recombined ultra-short baseline positioning data, and the points with obvious abnormal trend being eliminated, letting the trend of keeping the ultra-short baseline positioning data relatively consistent with the topography of AUV sounding data in the same area; and
A7: in terms of heading, with the assistance of ship-borne GPS positioning data, monitoring change frequencies of two sets of positioning data with change positions of time and ultra-short baseline positioning data in heading, being supplemented by navigation direction and speed data, and eliminating abnormal data of ultra-short baseline in X direction.

3. The positioning correction method according to claim 2, wherein the method for judging the abnormality of the first water depth value in step A2 is to arrange the ultra-short baseline positioning data of a survey line in time sequence in the direction of the first water depth value of the four-dimensional elimination model to obtain the abnormal water depth point, and to eliminate the ultra-short baseline positioning data of the abnormal point.

4. The positioning correction method according to claim 1, wherein S3 specifically comprises the following steps:
B1: respectively calculating correction coefficients of longitude and latitude after removing abnormal points by a cubic polynomial least square fitting method, and determining a fitting formula according to the correction coefficients; and
B2: fitting the processed recombined ultra-short baseline positioning data by using the fitting formula, and further determining the correction model by testing fitting effects of the recombined ultra-short baseline positioning data after removing anomalies.

5. The positioning correction method according to claim 4, wherein before the fitting formula in step B1 is determined, the data is centralized and standardized, and the determined fitting formula is expressed as follows:
f(x)=p₁x³+p₂x²+p₃x+p₄
among them, p₁, p₂, p₃ are the correction coefficient, and x is the number of all points.

6. The positioning correction method according to claim 4, wherein error data, which is generated by time change of the processed recombined ultra-short baseline positioning data on the ultra-short baseline heading, is corrected by the fitting formula in step B2, and the ultra-short baseline positioning data after spatial fitting is simulated with time as the constraint, which is video positioning data.

7. The positioning correction method according to claim 1, wherein after the near-seabed video positioning is obtained in S4, part of the ultra-short baseline positioning data with good quality is picked out to be compared with the corresponding positioning data predicted by interpolation to verify the effectiveness of the video positioning correction method.
